(19) United States
(12) Patent Application Publication
(10) Pub. No.: US 2020/0097136 A1
(43) Pub. Date: Mar. 26, 2020

(54) TECHNIQUES AND ARCHITECTURES FOR PERSISTENT PRIVATE LISTS IN A COMPLEX COMPUTING ENVIRONMENT

(71) Applicant: salesforce.com, inc., San Francisco, CA (US)

(72) Inventor: Emily Behrendt, Seattle, WA (US)

(21) Appl. No.: 16/139,498

(22) Filed: Sep. 24, 2018

(51) Int. Cl. G06F 3/0482; G06F 17/30

(52) U.S. Cl. CPC G06F 3/0482; G06F 17/30997; G06F 17/30716

(57) ABSTRACT

A persistent list interface object is maintained within a graphical user interface available to a user of an on-demand services environment. The persistent list interface object is presented on the graphical user interface when graphical user interface presents multiple different domains within the on-demand services environment. The persistent list interface object maintains a list corresponding to a specific user. One or more items are added to the persistent list via a shortcut link in the graphical user interface. The one or more items correspond to at least one graphical object within a current domain of the on-demand services environment. Adding the one or more items to the persistent list comprises adding text and/or graphics corresponding to the one or more items to the persistent list. Data and metadata associated with the one or more items are stored in a database communicatively coupled with the graphical user interface. Access to the persistent list is provided via the graphical interface used to access the on-demand services environment across access to and/or utilization of multiple domains within the on-demand services environment.

### TECHNICAL FIELD

Embodiments relate to techniques for maintaining a persistent list in a complex computing environment. More particularly, embodiments relate to techniques for maintaining a persistent list (e.g., to do list, org flow) in a computing environment having multiple domains where the list is maintained and presented consistently in the multiple domains.

### BACKGROUND

There are a number of tools available to keep track of a to-do lists at work, such as the Reminders app on Mac, tasks in Google Calendar, various web apps, a simple text file, or plain pen and paper. However, there is not any good way to do this within more complex work environments (e.g., salesforce environment, CRM environments, small office productivity suites). Given how much time is spent in in these environments, it would be beneficial to have a more efficient mechanism for managing lists (e.g., to-do lists).

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an example social media graphical user interface that can provide mechanisms to support a persistent list as described herein.

FIG. 2 is an illustration of an example social media graphical user interface that can provide mechanisms to support additions to a persistent list as described herein.

FIG. 3 is an illustration of an example social media graphical user interface that can provide a persistent to do list as described herein.

FIG. 4 is an illustration of an example social media domain that can provide a persistent to do list as described herein.

FIG. 5 is an illustration of an example social media domain that can provide a persistent to do list as described herein where the list has been minimized.

FIG. 6 is an illustration of one embodiment of a persistent list with an item marked completed.

FIG. 7 is an illustration of an example home domain that can provide a persistent to do list as described herein.

FIG. 8 is an illustration of an example home domain that can provide a persistent to do list as described herein when the list has been minimized.

FIG. 9 is an illustration of an example accounts domain that can provide a persistent to do list as described herein.

FIG. 10 is an illustration of an example accounts domain that can provide a persistent to do list as described herein when the list has been minimized.

FIG. 11 is an illustration of an example detailed accounts domain that can provide a persistent to do list as described herein.

FIG. 12 is an illustration of an example detailed accounts domain that can provide a persistent to do list as described herein when the list has been minimized.

FIG. 13 illustrates a block diagram of an environment where an on-demand database service might be used.

FIG. 14 illustrates a block diagram of an environment where an on-demand database service might be used.

FIG. 15 is a flow diagram of one embodiment of a technique to provide a persistent list in a multi-domain environment.

FIG. 16 is a block diagram of a persistent list agent.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

Specific example use cases are discussed herein with respect to Chatter, which is an enterprise social networking platform available from salesforce.com of San Francisco, Calif. However, the list making (and maintenance) techniques described herein can be applied in other environment and with other platforms. The examples provided herein are generally presented in terms of to-do lists; however, the techniques described herein are applicable to other types of lists (and other information) that is useful to be persistently presented across multiple domains, for example, a work (e.g., hourly) timer, a directory, a parts/component list, an organization chart/description.

Oftentimes, the most important messages (e.g., email, social media posts, Chatter posts) are ones that prompt users to take some action or accomplish some task. If the user does not have time to take that action at the time of reading the message (or post) then there is no mechanism for them to make note of the message or task without navigating away from the current environment, resulting in context switching which is dangerous for productivity. For example, they can either bookmark the post and try to remember to come back to it later (bookmarking would require combing through many posts with no options for organization), or they can add that action to a to-do list outside of platform through which the message was delivered. These are error-prone and inefficient solutions.

Described in greater detail below is a to-do list within a social media platform (e.g., Chatter), that is ever present even as the user navigates between different areas of a host environment that provides access to multiple domains (e.g., Salesforce—Commerce Cloud, Chatter, Sales Cloud, Data Cloud, Analytics Cloud, Internet of Things [IoT]). In one embodiment, any post can be added to the to-do list directly through an option on a persistent menu available in a graphical user interface that provides access to the platform being used.

This has the benefit of keeping the user from having to navigate out of current work environment and avoids context-switching. This helps the user to keep their focus, and not get distracted by the to-dos presented by these posts, because it is so quick and easy to add to to-do list and file that item away for later. In one embodiment, this to-do list is private to the user, so no one else can view or modify their list. As mentioned above, other types of lists can also be maintained.

In one embodiment, list persistence can be accomplished utilizing a graphical user interface (GUI) object that remains present in the graphical user interface as a user navigates between domains. Thus, using the salesforce example, the GUI object can remain present on a user's interface as the user navigates from Chatter to Sales Cloud to Analytics Cloud, for example. In various embodiments, the GUI object can be maximized, minimized and/or closed by external (e.g., user) inputs. This can allow, for example, a social media (e.g., Chatter) post to be added directly to the persistent list through an option within the persistent GUI object.

In one embodiment, the persistent GUI object appears as soon as a user adds an item to the list. From there, the list can be minimized or maximized, and will stay visible on any page within the computing environment. If a user closes the docked element, they can re-open it by adding another element to the list. In another embodiment, a user can open the docked element through a global actions button within a user interface, for example.

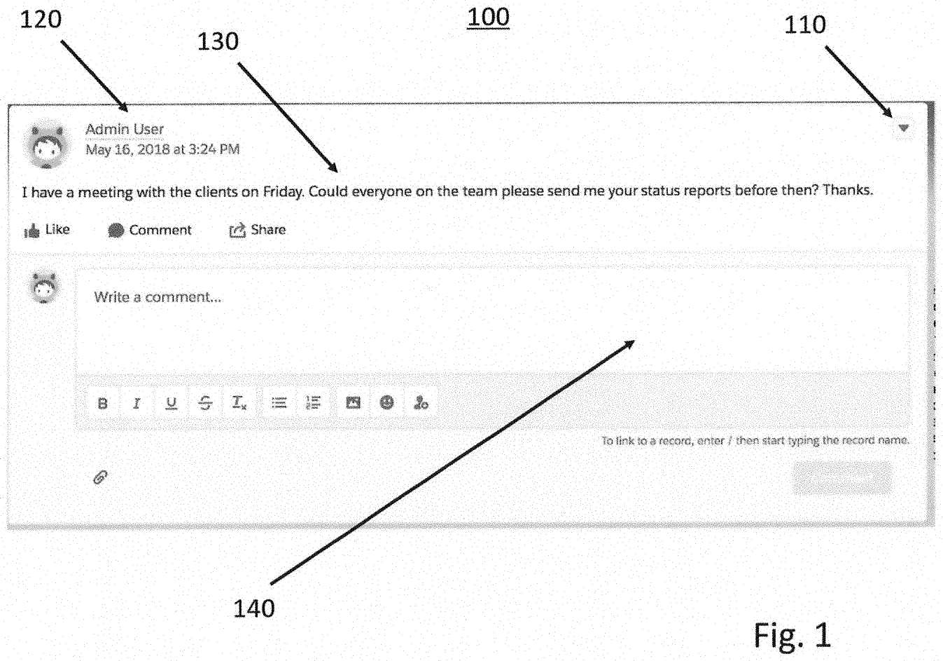

FIG. 1 is an illustration of an example social media graphical user interface that can provide mechanisms to support a persistent list as described herein. The example of FIGS. 1-5 correspond to a version of Chatter available within the salesforce environment, which is available from salesforce.com of San Francisco, Calif. In alternate embodiments, other interfaces (e.g., email, social media, instant messaging) and/or environments can be supported.

Social media interface 100 can include action menu 110 and user post 120 as well as other elements (not illustrated in FIG. 1). User post 120 can include, for example, post body 130, which is the textual content provided in user post 120 as well as comment field 140. User post 120 can include other elements, for example, like button, dislike button, share button, attachment button, emoji button, etc.

In the current example use case, a user may read post body 130, “I have a meeting with the clients on Friday. Could everyone on the team please send me your status reports before then? Thanks.” In response to reading this post a user can determine that they have a future task to accomplish. This user may wish to add the task to their to do (task, activity, action item) list. Various other features and embodiments are described below.

In one embodiment, the user can add items to their list using action menu 110, which is described in greater detail below. In various embodiments, action menu 110 can allow a user to automatically create a list item from one or more user interface objects (e.g., post body 130).

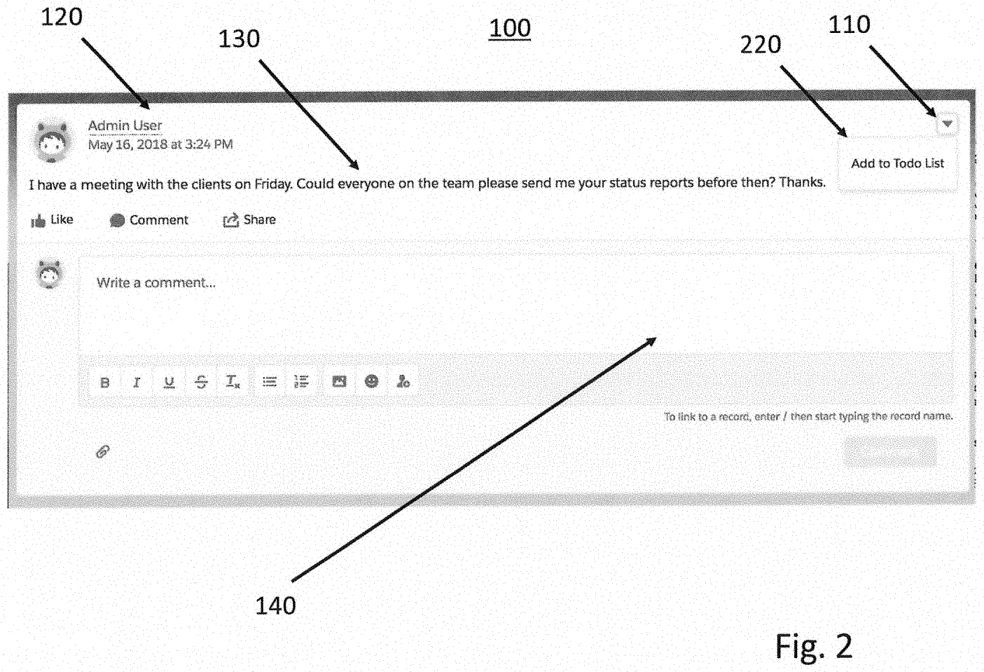

FIG. 2 is an illustration of an example social media graphical user interface that can provide mechanisms to support additions to a persistent list as described herein. In the example of FIG. 2, the user can select action menu 110 to reveal one or more menu items 220 (e.g., “Add to To Do List”). Any number of actions can be supported through action menu 110. In one example embodiment, when a user selects action menu 110 by interacting with the corresponding user interface (UI) component, menu item(s) 220 can be revealed.

In one embodiment, action menu 110 or a corresponding menu object is available through the UI in any domain of a host computing environment that include the social media feed of FIGS. 1-5. In the salesforce example, a persistent list object corresponding to action menu 110 and/or the to-do list (e.g., 315 as discussed below) can be available outside of the social media domain (e.g., in a CRM domain, in an analytics domain, in a communications domain) so that the list being managed is constantly available to the user.

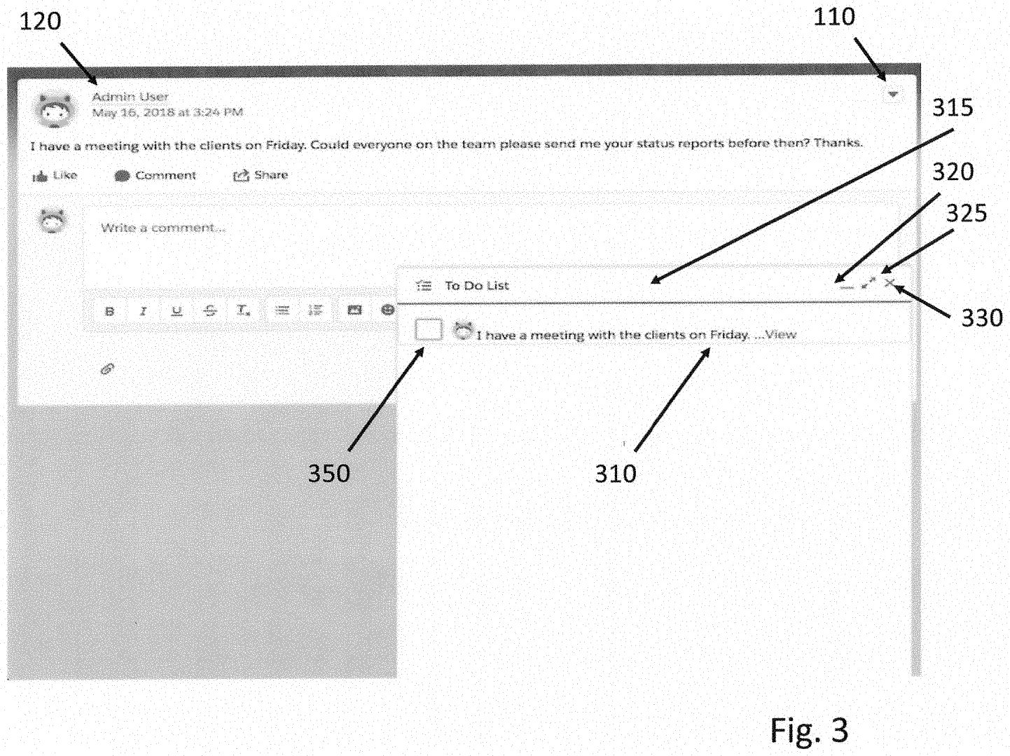

FIG. 3 is an illustration of an example social media graphical user interface that can provide a persistent to do list as described herein. In one embodiment, in response to selection of “Add to To Do List” from menu item(s) 220 (illustrated in FIG. 2 and not in FIG. 3), To Do List 315 can be displayed within the social media domain. In one embodiment, the text from the selected social media post (e.g., post body 130) can be automatically added to To Do List 315 as list item 310. In alternate embodiments, other types of lists can be maintained in a similar manner.

In various embodiments, items in the list can have associated additional elements (e.g., links, attachments, graphics). In various embodiments, To Do List 315 can have associated menu items (e.g., filter, share, minimize, maximize). In one embodiment, To Do List 315 can have graphical components for indicating that the associated task has been completed (e.g., check box 350). In one embodiment, a menu bar (or other interface item) can allow a user to minimize (320), maximize (325) or close (330) To Do List 315. In one embodiment, list items can have links back to the original post/message used to create the list item.

In various embodiments, a user can view, modify, prioritize, edit, rearrange (or any combination thereof) items on their list. In some embodiments, users can have multiple persistent lists (e.g., short-term tasks, long-term tasks).

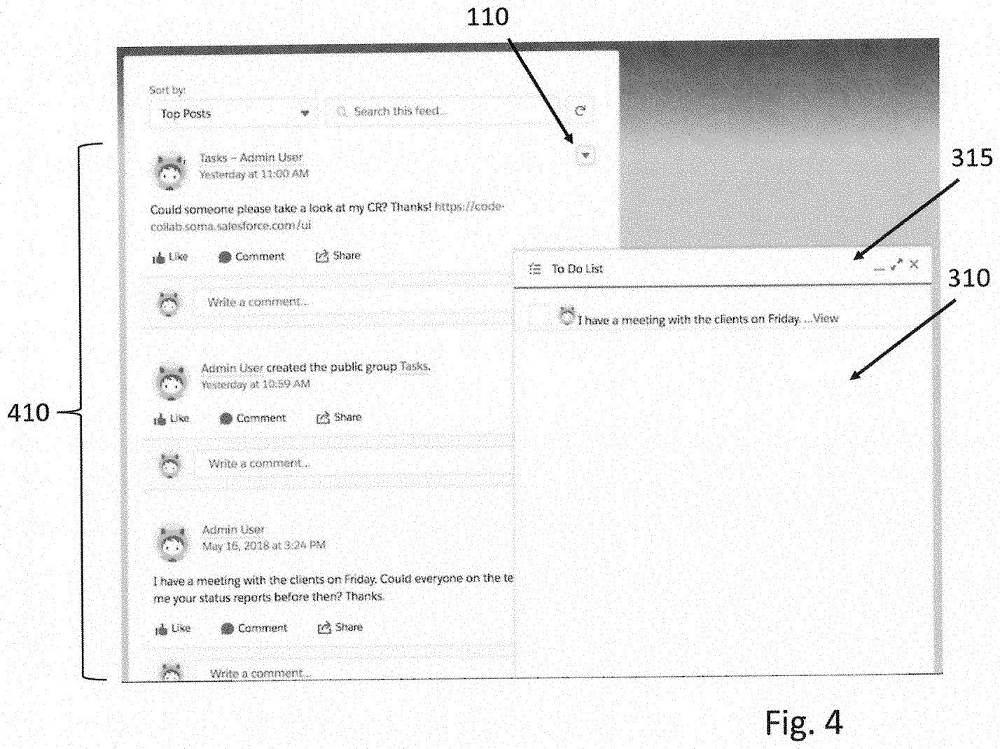

FIG. 4 is an illustration of an example social media domain that can provide a persistent to do list as described herein. FIG. 4 illustrates how To Do List 315 can be presented within a social media domain having at least one feed 410. Feed 410 generally represents any mechanism for exchange of social media content that can also be referred to, for example, as a wall, a screen cast, a news feed. Generally, any mechanism that allows user to share information, ideas, messages, audio and/or video content, etc.

As discussed above, To Do List 315 can be minimized or maximized within the domain. The list can also float or be presented in any other manner within the social media domain. Similarly, the list can be presented in any manner within other (non-social media) domains.

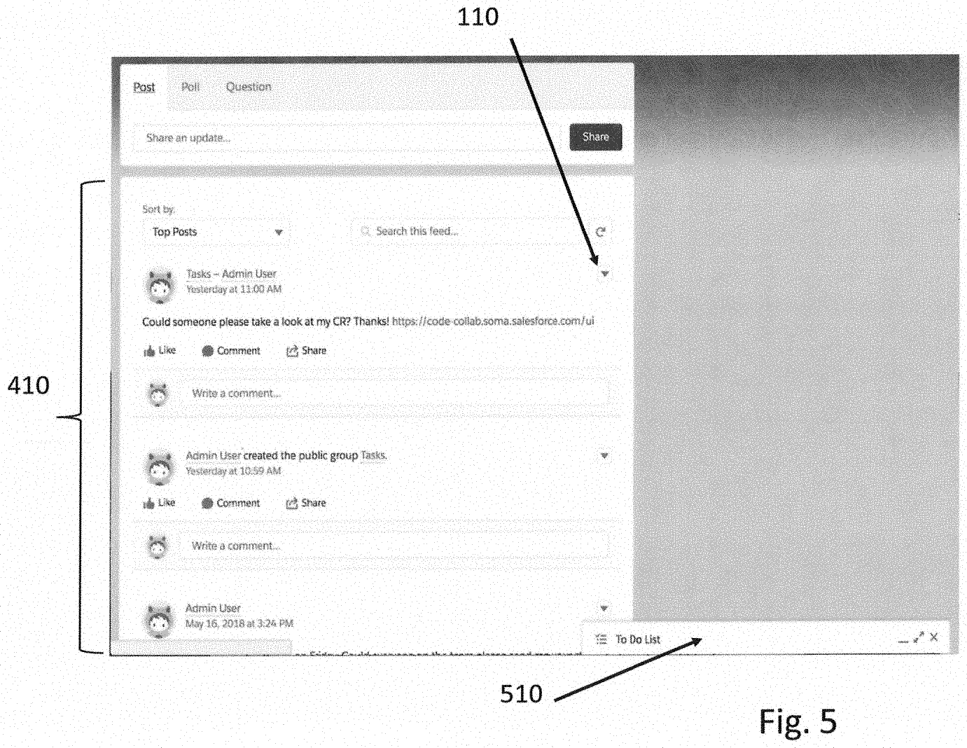

FIG. 5 is an illustration of an example social media domain that can provide a persistent to do list as described herein where the list has been minimized. FIG. 5 illustrates how the To Do List of FIG. 4 can be presented within a social media domain having at least one feed 410 in a minimized state, 510. Similarly, the list can be presented in any manner within other (non-social media) domains.

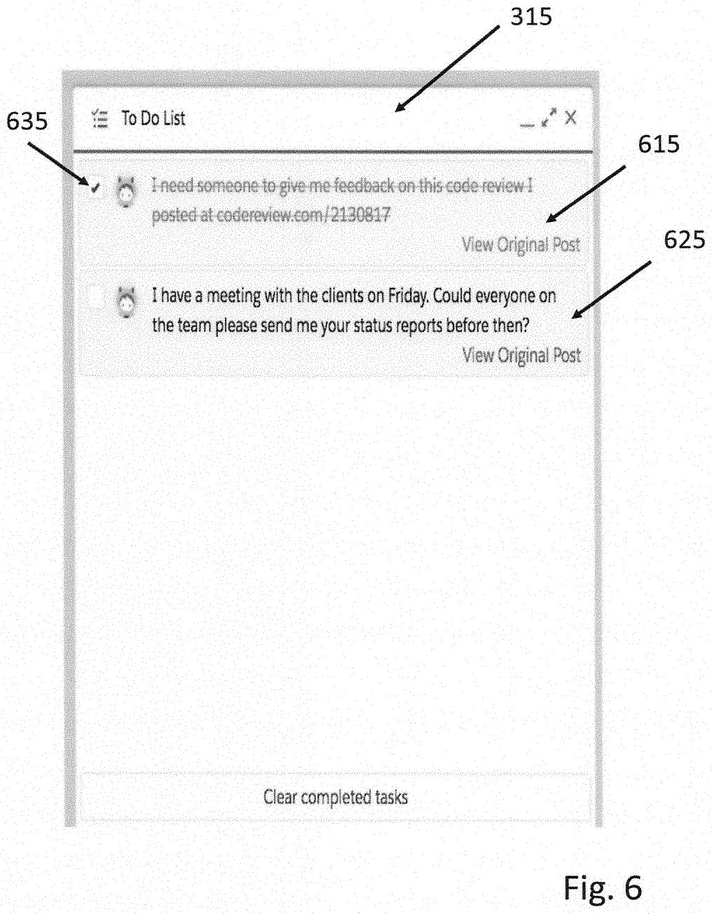

FIG. 6 is an illustration of one embodiment of a persistent list with an item marked completed. In the example of FIG. 6, item 615 has been completed and item 625 has not yet been marked as completed. In one embodiment, the completed items can be shown in strikethrough (or other format indicator). In alternate embodiments, completed items can be removed from To Do list 315. In one embodiment, check box 635 can be a UI mechanism through which the user marks an item as complete. In alternate embodiments, other mechanisms can be provided.

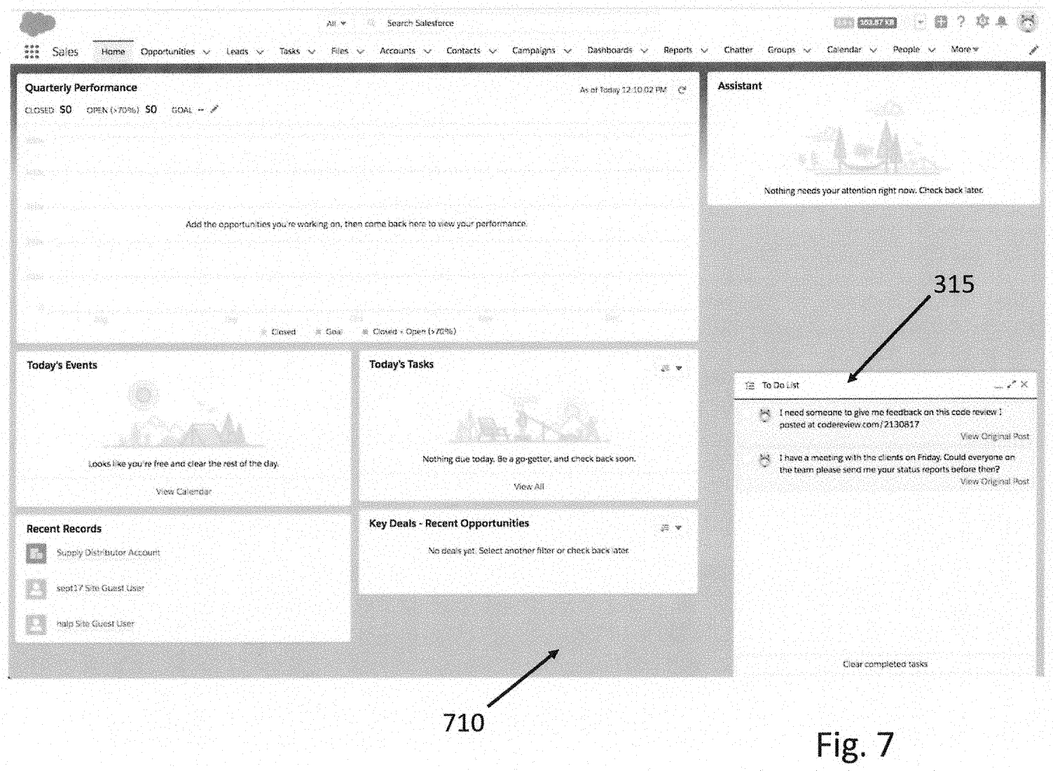

FIG. 7 is an illustration of an example home domain that can provide a persistent to do list as described herein. In the example of FIG. 7, To Do List 315 is illustrated in home domain 710 in an expanded format. In some embodiments, one or more items of To Do List 315 can have a link (720) to supporting content (e.g., social media post from which the item was created). While the format of To Do List 315 is the same in home domain 710 as in the social media domain discussed above, the format can also be different in different domains while providing a consistent listing of items.

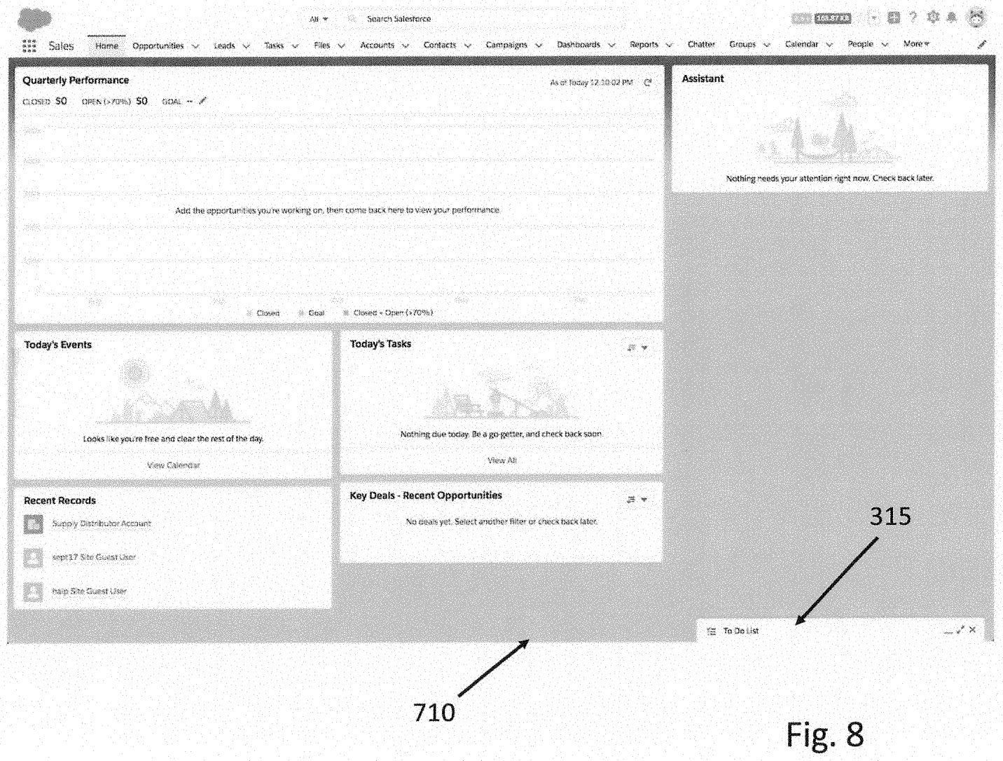

FIG. 8 is an illustration of an example home domain that can provide a persistent to do list as described herein when the list has been minimized. In the example of FIG. 8, To Do List 315 is illustrated in home domain 710 in a minimized format.

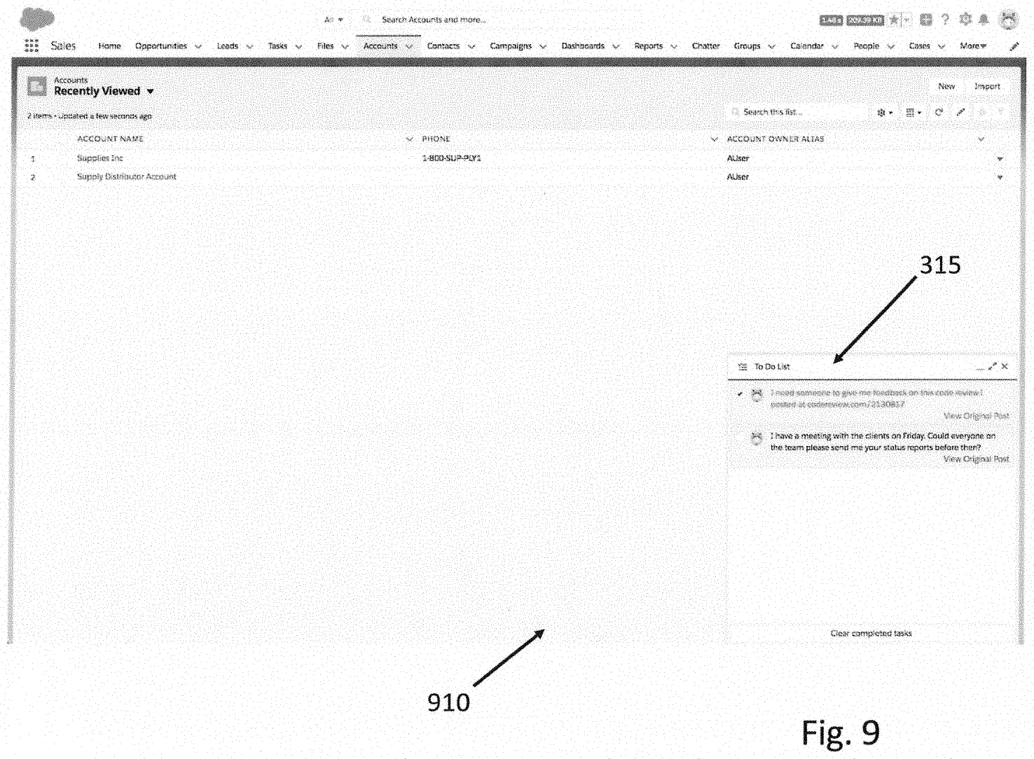

FIG. 9 is an illustration of an example accounts domain that can provide a persistent to do list as described herein. In the example of FIG. 9, To Do List 315 is illustrated in accounts domain 910 in an expanded format. In some embodiments, one or more items of To Do List 315 can have a link (920) to supporting content (e.g., social media post from which the item was created). While the format of To Do List 315 is the same in accounts domain 910 as in the social media domain discussed above, the format can also be different in different domains while providing a consistent listing of items.

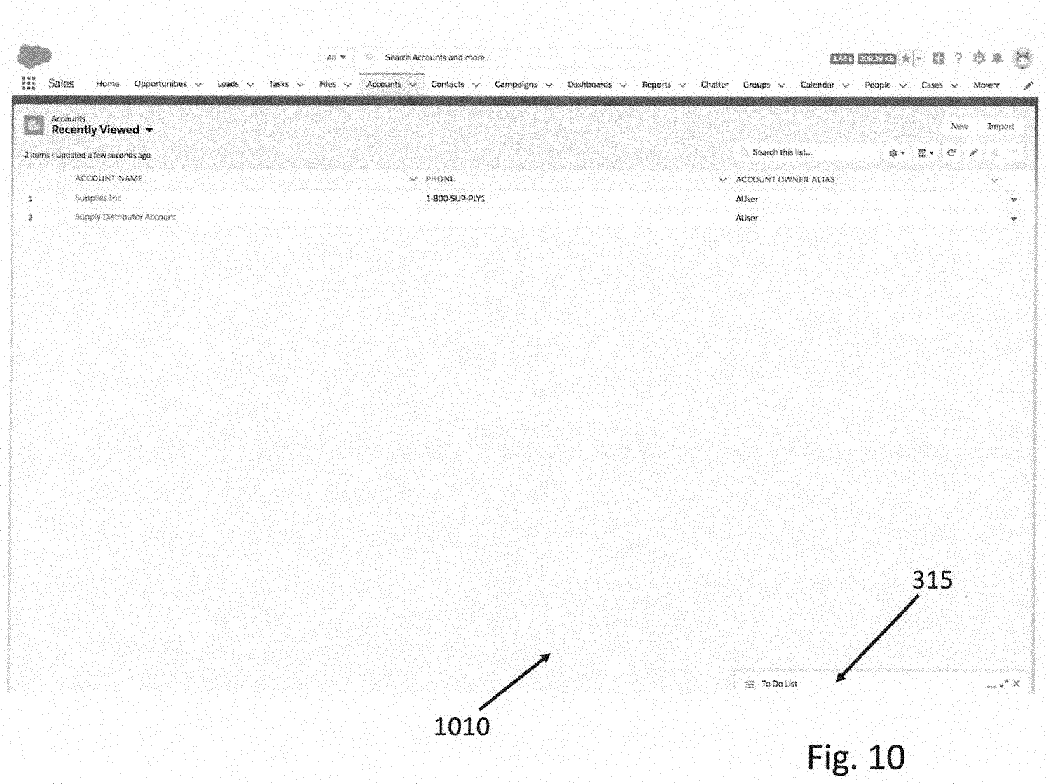

FIG. 10 is an illustration of an example accounts domain that can provide a persistent to do list as described herein when the list has been minimized. In the example of FIG. 10, To Do List 315 is illustrated in accounts domain 1010 in a minimized format.

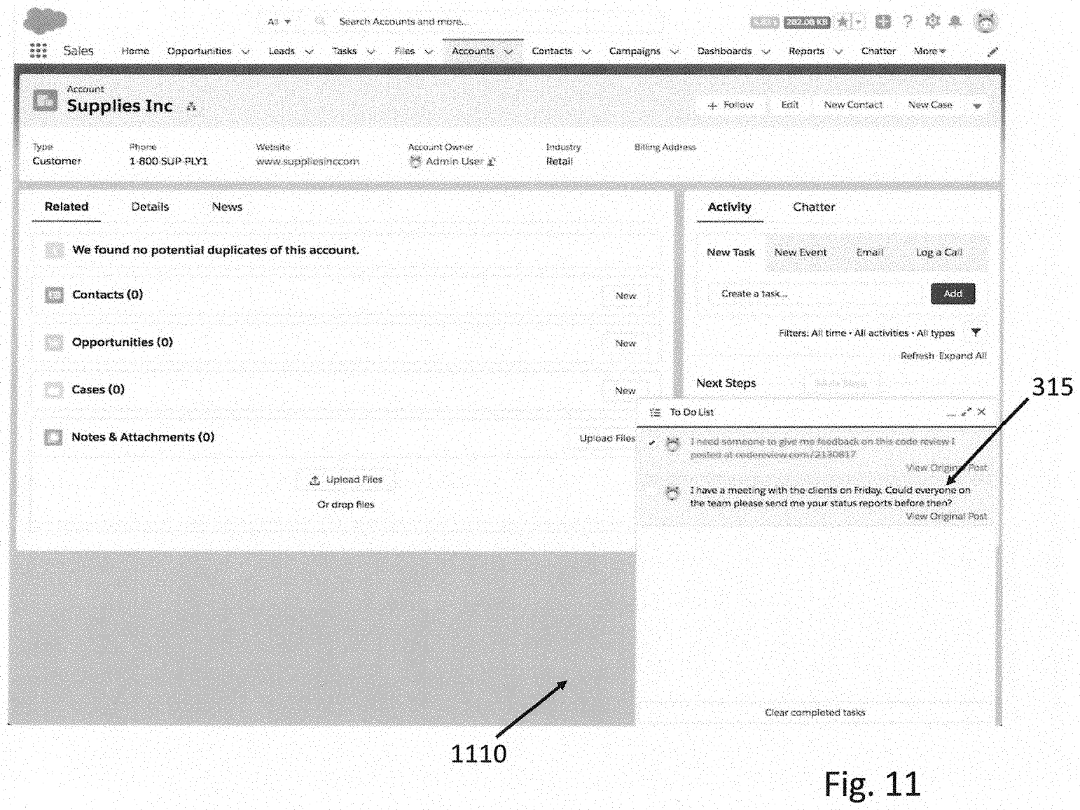

FIG. 11 is an illustration of an example detailed accounts domain that can provide a persistent to do list as described herein. In the example of FIG. 11, To Do List 315 is illustrated in accounts domain 1110 in an expanded format. In some embodiments, one or more items of To Do List 315 can have a link (1120) to supporting content (e.g., social media post from which the item was created). While the format of To Do List 315 is the same in accounts domain 1110 as in the social media domain discussed above, the format can also be different in different domains while providing a consistent listing of items.

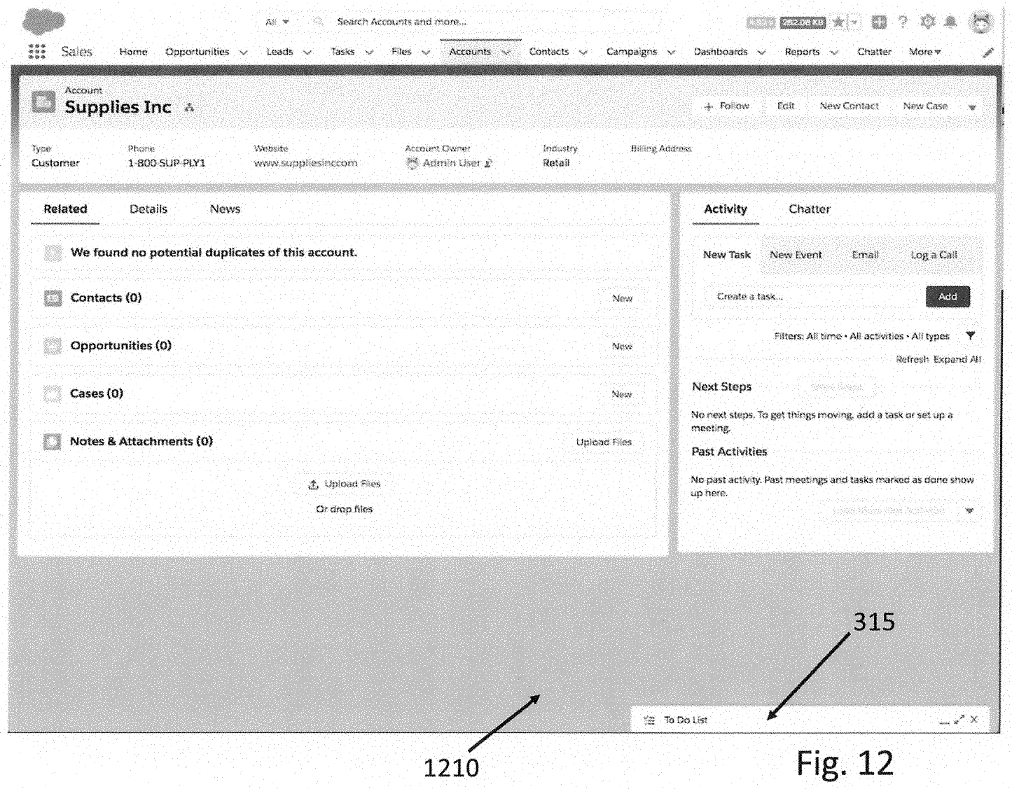

FIG. 12 is an illustration of an example detailed accounts domain that can provide a persistent to do list as described herein when the list has been minimized. In the example of FIG. 12, To Do List 315 is illustrated in accounts domain 1210 in a minimized format.

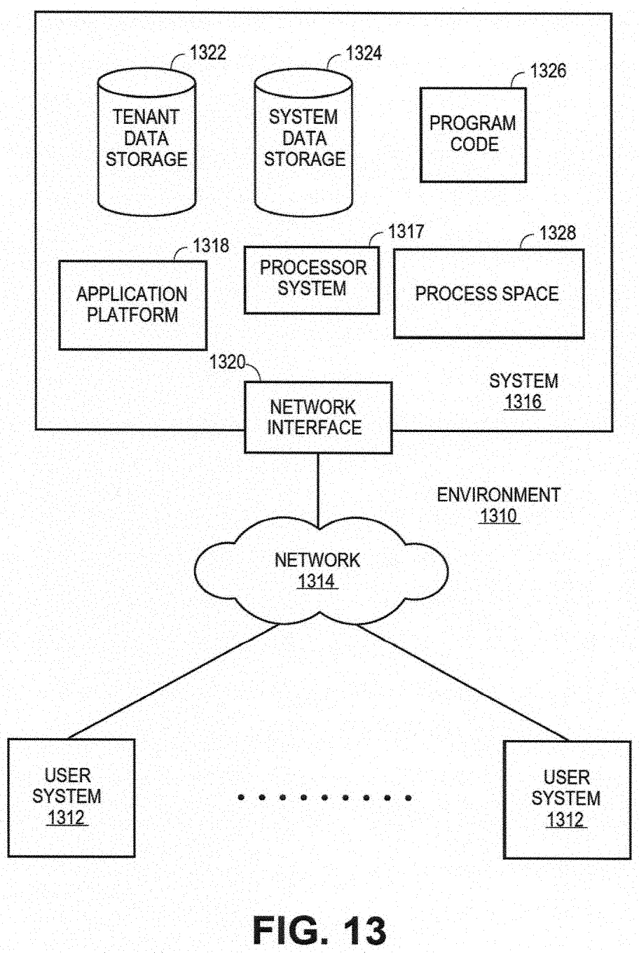

FIG. 13 illustrates a block diagram of an environment 1310 wherein an on-demand database service might be used. Environment 1310 may include user systems 1312, network 1314, system 1316, processor system 1317, application platform 1318, network interface 1320, tenant data storage 1322, system data storage 1324, program code 1326, and process space 1328. In other embodiments, environment 1310 may not have all of the components listed and/or may have other elements instead of, or in addition to, those listed above.

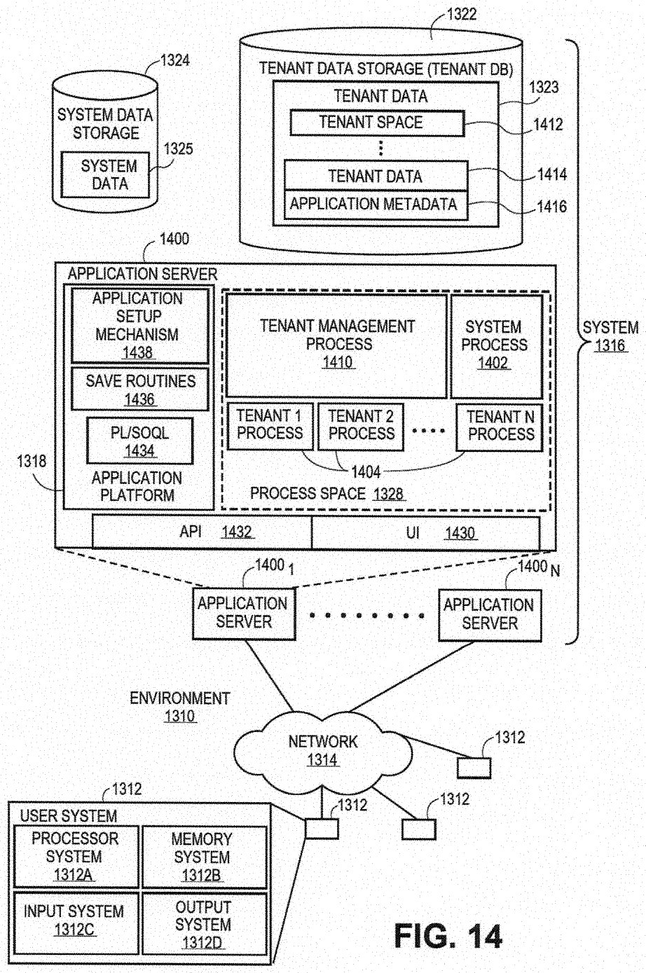

Environment 1310 is an environment in which an on-demand database service exists. User system 1312 may be any machine or system that is used by a user to access a database user system. For example, any of user systems 1312 can be a handheld computing device, a mobile phone, a laptop computer, a work station, and/or a network of computing devices. As illustrated in herein FIG. 13 (and in more detail in FIG. 14) user systems 1312 might interact via a network 1314 with an on-demand database service, which is system 1316.

An on-demand database service, such as system 1316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1316” and “system 1316” will be used interchangeably herein.

A database image may include one or more database objects. A relational database management system (RDMS) or the equivalent may execute storage and retrieval of information against the database object(s). Application platform 1318 may be a framework that allows the applications of system 1316 to run, such as the hardware and/or software, e.g., the operating system. In an embodiment, on-demand database service 1316 may include an application platform 1318 that enables creation, managing and executing one or more applications developed by the provider of the on-demand database service, users accessing the on-demand database service via user systems 1312, or third party application developers accessing the on-demand database service via user systems 1312.

The users of user systems 1312 may differ in their respective capacities, and the capacity of a particular user system 1312 might be entirely determined by permissions (permission levels) for the current user. For example, where a salesperson is using a particular user system 1312 to interact with system 1316, that user system has the capacities allotted to that salesperson. However, while an administrator is using that user system to interact with system 1316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1314 is any network or combination of networks of devices that communicate with one another. For example, network 1314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 1312 might communicate with system 1316 using TCP/IP and, at a higher network level, use other common Internet protocols to communicate, such as HTTP, FTP, AFS, WAP, etc. In an example where HTTP is used, user system 1312 might include an HTTP client commonly referred to as a “browser” for sending and receiving HTTP messages to and from an HTTP server at system 1316. Such an HTTP server might be implemented as the sole network interface between system 1316 and network 1314, but other techniques might be used as well or instead. In some implementations, the interface between system 1316 and network 1314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 1316, shown in FIG. 13, implements a web-based customer relationship management (CRM) system. For example, in one embodiment, system 1316 includes application servers configured to implement and execute CRM software applications as well as provide related data, code, forms, webpages and other information to and from user systems 1312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared.

In certain embodiments, system 1316 implements applications other than, or in addition to, a CRM application. For example, system 1316 may provide tenant access to multiple hosted (standard and custom) applications, including a CRM application. User (or third party developer) applications, which may or may not include CRM, may be supported by the application platform 1318, which manages creation, storage of the applications into one or more database objects and executing of the applications in a virtual machine in the process space of the system 1316.

One arrangement for elements of system 1316 is shown in FIG. 13, including a network interface 1320, application platform 1318, tenant data storage 1322 for tenant data 1323, system data storage 1324 for system data 1325 accessible to system 1316 and possibly multiple tenants, program code 1326 for implementing various functions of system 1316, and a process space 1328 for executing MTS system processes and tenant-specific processes, such as running applications as part of an application hosting service. Additional processes that may execute on system 1316 include database indexing processes.

Several elements in the system shown in FIG. 13 include conventional, well-known elements that are explained only briefly here. For example, each user system 1312 could include a desktop personal computer, workstation, laptop, PDA, cell phone, or any wireless access protocol (WAP) enabled device or any other computing device capable of interfacing directly or indirectly to the Internet or other network connection. User system 1312 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 1312 to access, process and view information, pages and applications available to it from system 1316 over network 1314.

Each user system 1312 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 1316 or other systems or servers. For example, the user interface device can be used to access data and applications hosted by system 1316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1312 and all of its components are operator configurable using applications, such as a browser, including computer code run using a central processing unit such as an Intel Core series processor or the like. Similarly, system 1316 (and additional instances of an MTS, where more than one is present) and all of their components might be operator configurable using application(s) including computer code to run using a central processing unit such as processor system 1317, which may include an Intel Core series processor or the like, and/or multiple processor units. A computer program product embodiment includes a machine-readable storage medium (media) having instructions stored thereon/in which can be used to program a computer to perform any of the processes of the embodiments described herein.

Computer code for operating and configuring system 1316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1316 is configured to provide webpages, forms, applications, data and media content to user (client) systems 1312 to support the access by user systems 1312 as tenants of system 1316. As such, system 1316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B).

As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 14 also illustrates environment 1310. However, in FIG. 14 elements of system 1316 and various interconnections in an embodiment are further illustrated. FIG. 14 shows that user system 1312 may include processor system 1312A, memory system 1312B, input system 1312C, and output system 1312D. FIG. 14 shows network 1314 and system 1316. FIG. 14 also shows that system 1316 may include tenant data storage 1322, tenant data 1323, system data storage 1324, system data 1325, User Interface (UI) 1430, Application Program Interface (API) 1432, PL/SOQL 1434, save routines 1436, application setup mechanism 1438, applications servers 1400₁-1400_{N}, system process space 1402, tenant process spaces 1404, tenant management process space 1410, tenant storage area 1412, user storage 1414, and application metadata 1416. In other embodiments, environment 1310 may not have the same elements as those listed above and/or may have other elements instead of, or in addition to, those listed above.

User system 1312, network 1314, system 1316, tenant data storage 1322, and system data storage 1324 were discussed above in FIG. 13. Regarding user system 1312, processor system 1312A may be any combination of one or more processors. Memory system 1312B may be any combination of one or more memory devices, short term, and/or long term memory. Input system 1312C may be any combination of input devices, such as one or more keyboards, mice, trackballs, scanners, cameras, and/or interfaces to networks. Output system 1312D may be any combination of output devices, such as one or more monitors, printers, and/or interfaces to networks.

As shown by FIG. 14, system 1316 may include a network interface 1320 (of FIG. 13) implemented as a set of HTTP application servers 1400, an application platform 1318, tenant data storage 1322, and system data storage 1324. Also shown is system process space 1402, including individual tenant process spaces 1404 and a tenant management process space 1410. Each application server 1400 may be configured to tenant data storage 1322 and the tenant data 1323 therein, and system data storage 1324 and the system data 1325 therein to serve requests of user systems 1312. The tenant data 1323 might be divided into individual tenant storage areas 1412, which can be either a physical arrangement and/or a logical arrangement of data. Within each tenant storage area 1412, user storage 1414 and application metadata 1416 might be similarly allocated for each user. For example, a copy of a user's most recently used (MRU) items might be stored to user storage 1414. Similarly, a copy of MRU items for an entire organization that is a tenant might be stored to tenant storage area 1412. A UI 1430 provides a user interface and an API 1432 provides an application programmer interface to system 1316 resident processes to users and/or developers at user systems 1312. The tenant data and the system data may be stored in various databases, such as one or more Oracle™ databases.

Application platform 1318 includes an application setup mechanism 1438 that supports application developers' creation and management of applications, which may be saved as metadata into tenant data storage 1322 by save routines 1436 for execution by subscribers as one or more tenant process spaces 1404 managed by tenant management process 1410 for example. Invocations to such applications may be coded using PL/SOQL 1434 that provides a programming language style interface extension to API 1432. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 1416 for the subscriber making the invocation and executing the metadata as an application in a virtual machine.

Each application server 1400 may be communicably coupled to database systems, e.g., having access to system data 1325 and tenant data 1323, via a different network connection. For example, one application server 1400₁ might be coupled via the network 1314 (e.g., the Internet), another application server 1400_{N-1} might be coupled via a direct network link, and another application server 1400_{N} might be coupled by yet a different network connection. Transfer Control Protocol and Internet Protocol (TCP/IP) are typical protocols for communicating between application servers 1400 and the database system. However, it will be apparent to one skilled in the art that other transport protocols may be used to optimize the system depending on the network interconnect used.

In certain embodiments, each application server 1400 is configured to handle requests for any user associated with any organization that is a tenant. Because it is desirable to be able to add and remove application servers from the server pool at any time for any reason, there is preferably no server affinity for a user and/or organization to a specific application server 1400. In one embodiment, therefore, an interface system implementing a load balancing function (e.g., an F5 BIG-IP load balancer) is communicably coupled between the application servers 1400 and the user systems 1312 to distribute requests to the application servers 1400. In one embodiment, the load balancer uses a least connections algorithm to route user requests to the application servers 1400. Other examples of load balancing algorithms, such as round robin and observed response time, also can be used. For example, in certain embodiments, three consecutive requests from the same user could hit three different application servers 1400, and three requests from different users could hit the same application server 1400. In this manner, system 1316 is multi-tenant, wherein system 1316 handles storage of, and access to, different objects, data and applications across disparate users and organizations.

As an example of storage, one tenant might be a company that employs a sales force where each salesperson uses system 1316 to manage their sales process. Thus, a user might maintain contact data, leads data, customer follow-up data, performance data, goals and progress data, etc., all applicable to that user's personal sales process (e.g., in tenant data storage 1322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1316 might also maintain system level data usable by multiple tenants or other data. Such system level data might include industry reports, news, postings, and the like that are sharable among tenants.

In certain embodiments, user systems 1312 (which may be client systems) communicate with application servers 1400 to request and update system-level and tenant-level data from system 1316 that may require sending one or more queries to tenant data storage 1322 and/or system data storage 1324. System 1316 (e.g., an application server 1400 in system 1316) automatically generates one or more SQL statements (e.g., one or more SQL queries) that are designed to access the desired information. System data storage 1324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

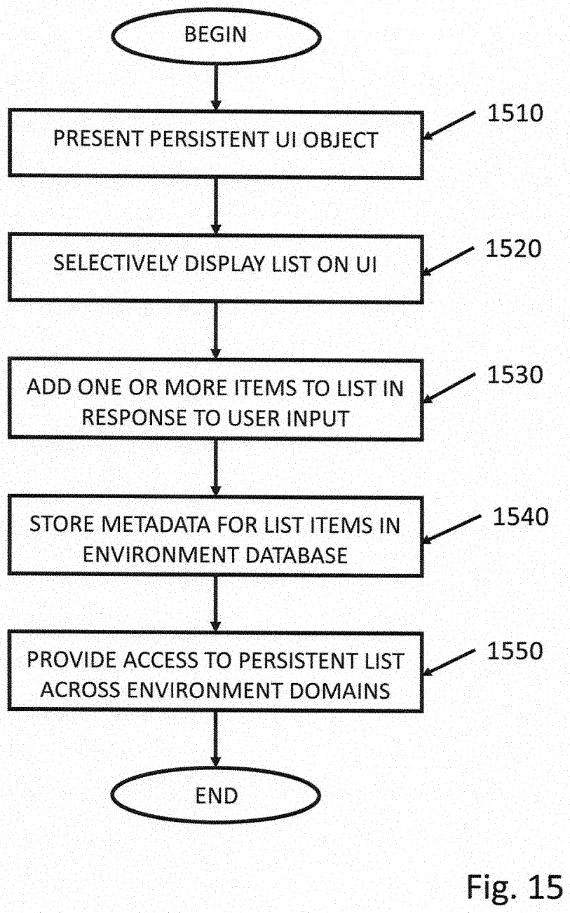

FIG. 15 is a flow diagram of one embodiment of a technique to provide a persistent list in a multi-domain environment. A persistent user interface (UI) object is presented, 1510. The UI object can be, for example, action menu 100 described above with respect to FIGS. 1-12.

The list corresponding to the UI object is selectively displayed on the UI, 1520. In some embodiments, the list can be hidden (or minimized) at times and fully visible at other times. For example, the list can operate as a popup item. In other embodiments, the list can be continuously displayed (either full size or reduced size).

One or more items can be added to the list in response to user input, 1530. The user input can be through the UI, as described above. In alternate embodiments, other techniques can be supported, for example, voice recognition, text/instant messaging, eye tracking, user gestures/movements. In some embodiments items on the list can be edited, prioritized and/or modified through the UI.

Metadata corresponding to the list is stored in a database, 1540. This metadata can be utilized to maintain/provide the list across multiple domains in the host environment. These domains can include, for example, one or more social media domains, CRM domain, an analytics domain, a database domain, etc. Access to the persistent list is provided across multiple domains in the host environment, 1550.

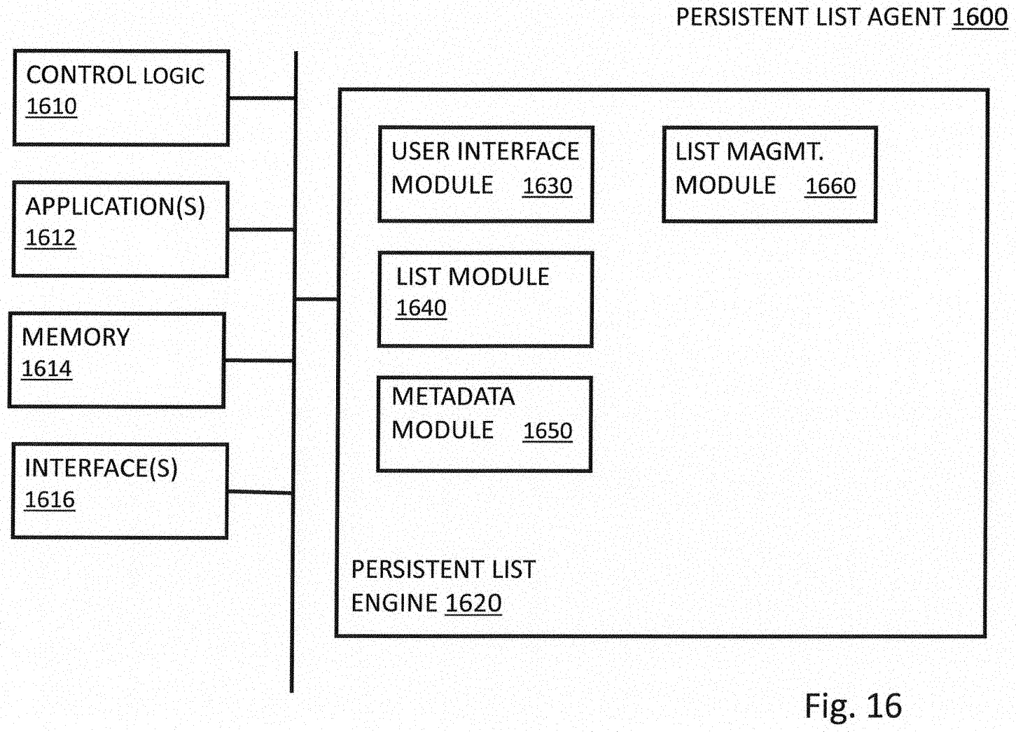

FIG. 16 is a block diagram of one embodiment of an agent to detect privilege escalation. In one embodiment, one or more privilege escalation detection agents may exist and/or operate within the host environment. The agent of FIG. 16 may persistent list functionality as described, for example, with respect to FIGS. 1-12. The agent of FIG. 16 may also provide additional functionality.

In one embodiment, persistent list agent 1600 includes control logic 1610, which implements logical functional control to direct operation of persistent list agent 1600, and/or hardware associated with directing operation of persistent list agent 1600. Logic may be hardware logic circuits and/or software routines. In one embodiment, persistent list agent 1600 includes one or more applications 1612, which represent a code sequence and/or programs that provide instructions to control logic 1610.

Persistent list agent 1600 includes memory 1614, which represents a memory device and/or access to a memory resource for storing data and/or instructions. Memory 1614 may include memory local to persistent list agent 1600, as well as, or alternatively, including memory of the host system on which persistent list agent 1600 resides. Persistent list agent 1600 also includes one or more interfaces 1616, which represent access interfaces to/from (an input/output interface) persistent list agent 1600 with regard to entities (electronic or human) external to persistent list agent 1600.

Persistent list agent 1600 also includes persistent list engine 1620, which represents one or more functions or module that enable persistent list agent 1600 to provide the index backups as described above. The example of FIG. 16 provides several modules that may be included in persistent list engine 1620; however, different and/or additional modules may also be included. Example modules that may be involved in providing the persistent list functionality include user interface module 1630, list module 1640, metadata module 1650 and list management module 1660. Each of these modules may further include other sub-modules to provide other functions. As used herein, a module refers to routine, a subsystem, logic circuit, microcode, etc., whether implemented in hardware, software, firmware or some combination thereof.

In one embodiment, user interface module 1630 functions to provide some or all of a graphical user interface on a display of a user computing device (e.g., mobile device, wearable device, laptop computer, desktop computer). As discussed above, the UI provides functionality across multiple domains as well as the persistent list described herein.

In one embodiment, list module 1640 functions to maintain one or more persistent lists across multiple domains within the host computing environment. The list can be displayed as a menu item, button, minimized list, maximized list, etc. In some embodiments, the visual presentation of the list is generally consistent across domains. In other embodiments, the visual presentation of the list can change depending on the current domain.

In one embodiment, metadata module 1650 functions to maintain metadata used to provide persistent lists across multiple domains. Metadata can include, for example, dates, times, priority data, ordering data, color coding, etc. In one embodiment, list management module 1660 functions to maintain the list contents across multiple domains. List management module 1660 can, for example, support editing of list entries and/or interactions with other modules to support list functionality.

As discussed above, the persistent list(s) can be provided within a multi-domain environment. Various embodiments of a multitenant multi-domain environment are described in greater detail below.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more hardware processors, are configurable to cause the one or more processors to:
maintain a persistent list interface object within a graphical user interface available to a user of an on-demand services environment, wherein the persistent list interface object is presented on the graphical user interface when graphical user interface presents multiple different domains within the on-demand services environment, the persistent list interface object to maintain a list corresponding to a specific user;
add one or more items to the persistent list via a shortcut link in the graphical user interface, the one or more items corresponding to at least one graphical object within a current domain of the on-demand services environment, wherein adding the one or more items to the persistent list comprises adding text and/or graphics corresponding to the one or more items to the persistent list;
store data and metadata associated with the one or more items in a database communicatively coupled with the graphical user interface;
provide access to the persistent list via the graphical interface used to access the on-demand services environment across access to and/or utilization of multiple domains within the on-demand services environment.

2. The non-transitory computer-readable medium of claim 1 wherein the persistent list comprises a to-do list.

3. The non-transitory computer-readable medium of claim 1 wherein the list is private for the specific user and is not available to other users of the on-demand services environment.

4. The non-transitory computer-readable medium of claim 1 wherein items maintained within the persistent list can be reordered through the persistent list interface object.

5. The non-transitory computer-readable medium of claim 1 wherein items maintained within the persistent list can be prioritized through the persistent list interface object.

6. The non-transitory computer-readable medium of claim 1 wherein items maintained within the persistent list can be shared with other users of the on-demand services environment through the persistent list interface object.

7. The non-transitory computer-readable medium of claim 1 wherein the on-demand services environment comprises at least a multitenant database environment.

8. A system comprising:
a memory system having at least one memory storage device;
one or more hardware processing devices coupled with the memory system, the one or more hardware processing devices to provide a multi-domain computing environment, the one or more hardware processing devices configurable to maintain a persistent list interface object within a graphical user interface available to a user of an on-demand services environment, wherein the persistent list interface object is presented on the graphical user interface when graphical user interface presents multiple different domains within the on-demand services environment, the persistent list interface object to maintain a list corresponding to a specific user, to add one or more items to the persistent list via a shortcut link in the graphical user interface, the one or more items corresponding to at least one graphical object within a current domain of the on-demand services environment, wherein adding the one or more items to the persistent list comprises adding text and/or graphics corresponding to the one or more items to the persistent list, to store data and metadata associated with the one or more items in a database communicatively coupled with the graphical user interface, and to provide access to the persistent list via the graphical interface used to access the on-demand services environment across access to and/or utilization of multiple domains within the on-demand services environment.

9. The system of claim 8 wherein the persistent list comprises a to-do list.

10. The system of claim 8 wherein the list is private for the specific user and is not available to other users of the on-demand services environment.

11. The system of claim 8 wherein items maintained within the persistent list can be reordered through the persistent list interface object.

12. The system of claim 8 wherein items maintained within the persistent list can be prioritized through the persistent list interface object.

13. The system of claim 8 wherein items maintained within the persistent list can be shared with other users of the on-demand services environment through the persistent list interface object.

14. The system of claim 8 wherein the on-demand services environment comprises at least a multitenant database environment.

15. A method comprising:
maintaining a persistent list interface object within a graphical user interface available to a user of an on-demand services environment, wherein the persistent list interface object is presented on the graphical user interface when graphical user interface presents multiple different domains within the on-demand services environment, the persistent list interface object to maintain a list corresponding to a specific user;
adding one or more items to the persistent list via a shortcut link in the graphical user interface, the one or more items corresponding to at least one graphical object within a current domain of the on-demand services environment, wherein adding the one or more items to the persistent list comprises adding text and/or graphics corresponding to the one or more items to the persistent list;
storing data and metadata associated with the one or more items in a database communicatively coupled with the graphical user interface;
providing access to the persistent list via the graphical interface used to access the on-demand services environment across access to and/or utilization of multiple domains within the on-demand services environment.

16. The method of claim 15 wherein the persistent list comprises a to-do list.

17. The method of claim 15 wherein the list is private for the specific user and is not available to other users of the on-demand services environment.

18. The method of claim 15 wherein items maintained within the persistent list can be reordered through the persistent list interface object.

19. The method of claim 15 wherein items maintained within the persistent list can be prioritized through the persistent list interface object.

20. The method of claim 15 wherein items maintained within the persistent list can be shared with other users of the on-demand services environment through the persistent list interface object.
